(19) United States
(12) Patent Application Publication
(10) Pub. No.: US 2020/0309439 A1
(43) Pub. Date: Oct. 1, 2020

(54) GEL-ICE GENERATORS AND RELATED SYSTEMS

(71) Applicant: NanoICE, Inc., Bothell, WA (US)

(72) Inventors: Jon Gunnarsson, Seattle, WA (US); Peyton McCann, Seattle, WA (US)

(21) Appl. No.: 16/756,048

(22) PCT Filed: Oct. 22, 2018
(86) PCT No.: PCT/US18/56929

§ 371 Date: Apr. 14, 2020

Related U.S. Application Data
(60) Provisional application No. 62/576,003, filed on Oct. 23, 2017.

(51) Int. Cl. F25C 1/145

(52) U.S. Cl. CPC F25C 1/145; A23B 4/08

(57) ABSTRACT

Systems and devices are provided for generating gel-ice. For example, a gel-ice generator is provided including a rotor apparatus to assist in moving flowable material through a gel-ice formation chamber. The rotor apparatus may include a rotor shaft positioned in the gel-ice formation chamber which is configured to rotate about a longitudinal axis during operation and to maintain flowable material within an annular column around the rotor shaft as the flowable material moves from an inlet end of the gel-ice formation chamber toward an outlet end of the gel-ice formation chamber. The gel-ice formation chamber may be surrounded by a coolant passage that spirals circumferentially along an exterior of the chamber. The rotor apparatus may further include a plurality of scraper elements supported on the rotor shaft to rotate in unison therewith to assist in the production of gel-ice as the rotor shaft rotates during operation by, among other things, scraping ice particles of a wall of a surrounding enclosure. The resultant gel-ice has a variety of uses, including for food processing and preservation.

### BACKGROUND

### Technical Field

The present disclosure relates to systems and devices for generating gel-ice.

### Description of the Related Art

Storage, processing or displaying a variety of items, such as foods, beverages, flowers and organs, requires a cold source. There are a number of problems related to presently available cold sources for many industries. For example, in the fisheries lines of business, which include fishing via vessels or aquaculture, it is desirable to obtain rapid chilling of fish and to maintain temperature control from catch to consumption. Rapid chilling of fish and subsequent temperature control can prevent injuries, trauma and degradation. Such prevention would result in a larger catch, or crop, of better quality fish with a longer shelf life. Known cold sources and systems for producing the same in the fisheries industry and other industries may be insufficient to meet desired needs or may suffer from a variety of deficiencies or drawbacks, such as, for example, inefficient production of such cold sources.

### BRIEF SUMMARY

Briefly stated, systems and devices for generating compositions of matter are provided. The compositions of matter are a cold source and, more specifically, are particular forms of ice with unexpectedly unique properties. More particularly, generators and related systems for generating gel-ice for use on or off land are provided, the gel-ice comprising ice-fraction components and at least one freezing level reducing component, wherein the at least one freezing level reducing component is in between the ice-fraction components. Examples of gel-ice which may be generated with the systems and devices described herein may be found in U.S. Patent Application Publication No. 2012/0000217, assigned to the present Applicant, which is incorporated herein by reference in its entirety.

The generators and related systems described herein are well suited to generate gel-ice to exacting standards in particularly efficient and versatile form factors.

According to one embodiment, a gel-ice generator apparatus may be summarized as including an inner tube having an inner surface defining at least a portion of a gel-ice formation chamber that includes an inlet end and an outlet end; an outer tube surrounding the inner tube to define a coolant chamber between the outer tube and the inner tube; one or more partitions arranged within the coolant chamber to provide a coolant passageway that spirals around the inner tube along at least a portion of a longitudinal length of the inner tube between a coolant inlet location and a coolant outlet location; and a rotor apparatus to assist in moving flowable material through the gel-ice formation chamber. The rotor apparatus may include a rotor shaft and a plurality of scraper elements positioned in the gel-ice formation chamber which are configured to rotate about a longitudinal axis during operation and to maintain flowable material within an annular column defined between the rotor shaft and the inner surface of the inner tube as the flowable material moves from the inlet end of the gel-ice formation chamber toward the outlet end of the gel-ice formation chamber.

The rotor apparatus may further include a plurality of scraper supports positioned on the rotor shaft to rotate in unison therewith; and the plurality of scraper elements may be positioned between the inner surface of the inner tube and the scraper supports to assist in the production of gel-ice as the rotor shaft rotates during operation.

The scraper supports of the rotor apparatus may maintain the scraper elements offset from the rotor shaft to define a gap between the scraper elements and an exterior surface of the rotor shaft. The scraper elements may be movably coupled to the scraper supports to enable radial displacement of the scraper elements during operation. The scraper elements may be movably coupled to the scraper supports to enable the scraper elements to tilt during operation. The scraper elements may include a leading surface configured such that interaction of the flowable material with the leading surface during operation drives the scraper elements to tilt relative to the scraper supports. The scraper elements may be arranged in an overlapping manner with respect to a direction along the longitudinal axis, and the size of generated ice particles may be smaller at formation regions corresponding to the areas of such overlap. Each scraper element may comprise an elongated element having opposing ends, and each scraper element may be supported at each of the opposing ends thereof by a respective scraper support. Each scraper element and a pair of respective scraper supports may form a tunnel for the flowable material.

The scraper supports may be provided in the form of blade elements. An arrangement of the blade elements may be configured to assist in moving the flowable material from the inlet end of the gel-ice formation chamber toward the outlet end of the gel-ice formation chamber. The arrangement of the blade elements may include a plurality of blade sub-groups spaced along a longitudinal length of the rotor shaft, each blade sub-group including a plurality of the blade elements arranged circumferentially about the rotor shaft. The rotor shaft and the blade elements may rotate as a unit to assist in the progression of the flowable material completely external of the rotor shaft. The blade elements may be canted relative to a transverse reference plane. An arrangement of the blade elements may form an intermittent conveying screw structure.

Each scraper support may include a projection extending radially outward away from the longitudinal axis, and each scraper element may include an aperture to receive the projection. The aperture of the scraper element may be sized to loosely receive the projection of the scraper support to enable the scraper element to tilt relative to the scraper support during operation. An external diameter of the rotor shaft may be less than half of an internal diameter of the inner tube. An external surface of the rotor shaft may be non-cylindrical. A thickness of each scraper element may be less than half of a radial distance between the external surface of the rotor shaft and the inner surface of the inner tube.

The gel-ice generator apparatus may further include a dispensing wheel coupled to the rotor shaft at the outlet end of the gel-ice formation chamber to rotate in unison with the rotor shaft. The dispensing wheel may include a plurality of compartments configured to receive gel-ice laterally and to dispense gel-ice radially, and each compartment may trail away in a direction opposite a direction of rotation of the rotor shaft. Each compartment may include opposing sidewalls that curve away from a direction of rotation of the rotor shaft. Each compartment may include a portion that extends radially inward beyond a reference circle defined by the scraper elements. Each compartment may include a portion that extends radially inward proximate a reference circle defined by an exterior surface of the rotor shaft.

The gel-ice generator apparatus may further include a gel-ice outlet aligned parallel to the longitudinal axis; and a conveying mechanism coupled to the rotor shaft at the outlet end of the gel-ice formation chamber to rotate in unison therewith with the conveying mechanism being configured to move gel-ice toward the gel-ice outlet.

The outer tube of the gel-ice generator may include a plurality of coolant inlet apertures configured to generate a relatively uniform temperature profile along a longitudinal length of the inner tube opposite the plurality of coolant inlet apertures. The plurality of coolant inlet apertures may include at least three distinct apertures, each aperture having a profile area of a different magnitude. The magnitude of the profile area of each aperture may be larger with increasing distance from a location of coolant introduction. The plurality of inlet apertures may be symmetrical about two distinct planes of symmetry.

The scraper elements may be arranged such that a concentric spacing between leading edges of concentrically adjacent scraper elements varies along the longitudinal axis in a stepped manner. The gel-ice generated during operation includes a bi-modal size distribution based at least upon the variance in concentric spacing between the leading edges of the concentrically adjacent scraper elements along the longitudinal axis.

The gel-ice generator apparatus may further include an extension spiral coupled to the rotor shaft at the outlet end of the gel-ice formation chamber downstream of the scraper elements. The extension spiral may include an outer member making at least one full revolution about the rotor shaft which is configured to move gel-ice toward the gel-ice outlet. The gel-ice generator apparatus may further include a dispensing wheel coupled to the rotor shaft at the outlet end of the gel-ice formation chamber downstream of the extension spiral to rotate in unison with the rotor shaft, the dispensing wheel having a plurality of compartments configured to receive gel-ice laterally and to dispense gel-ice radially.

According to another embodiment, a gel-ice manufacturing system may be summarized as including a drive motor; a plurality of gel-ice generators configured to receive fluid from a fluid supply, and a controller communicatively coupled to the drive motor, the controller being configured to command the drive motor to rotate each respective rotor apparatus concurrently to generate gel-ice via each of the plurality of gel-ice generators.

According to another embodiment, a gel-ice manufacturing system may be summarized as including a gel-ice generator configured to receive fluid from a fluid supply and discharge gel-ice; an inspection system including one or more sensors, the inspection system being in fluid communication with the gel-ice generator to at least periodically inspect one or more characteristics of gel-ice generated by the gel-ice generator and to generate an inspection signal in response thereto; and a controller communicatively coupled to the gel-ice generator and the inspection system, the controller being configured to adjust one or more operational parameters of the gel-ice generator based at least in part on the inspection signal generated by the inspection system.

According to yet another embodiment, a gel-ice manufacturing system may be summarized as including a gel-ice generator configured to receive fluid from a fluid supply and discharge gel-ice; a freezing level reducing agent control apparatus configured to receive a source of fluid and adjust and adjust a concentration of a freezing level reducing agent therein; and a controller communicatively coupled to the gel-ice generator and the freezing level reducing agent control apparatus, the controller being configured to independently control one or more operational parameters of the freezing level reducing agent control apparatus and the gel-ice generator to selectively adjust characteristics of the generated gel-ice. The freezing level reducing agent control apparatus may be configured to receive a source of water and adjust a salinity thereof. The freezing level reducing agent control apparatus may be configured to receive a source of water and adjust a salinity thereof to between about 0.9% to about 5.0% (% w/v).

According to still yet another embodiment, a gel-ice manufacturing system may be summarized as including a gel-ice generator configured to receive fluid from a fluid supply and discharge gel-ice; and a refrigerated storage tank in fluid communication with the gel-ice generator, the refrigerated storage tank including a rotatable auger to at least periodically mix gel-ice deposited in the refrigerated storage tank from the gel-ice generator during operation.

### BRIEF DESCRIPTION OF THE SEVERAL VIEWS OF THE DRAWINGS

FIG. 1 is an isometric view of an ice-gel generator, according to one example embodiment.

FIG. 2 is an isometric cross-sectional view of the gel-ice generator of FIG. 1 with an inner tube thereof shown transparent to reveal other internal structures.

FIG. 3 is another isometric cross-sectional view of the gel-ice generator of FIG. 1.

FIG. 4 is an enlarged portion of the isometric cross-sectional view shown FIG. 3 of the ice-generator of FIG. 1.

FIG. 5 is a side elevational view of the ice-gel generator of FIG. 1 with an inner tube thereof shown transparent to reveal other internal structures.

FIG. 6 is a cross-sectional view of the ice-gel generator of FIG. 1 taken along line 6-6 in FIG. 1.

FIG. 7 is a cross-sectional view of the ice-gel generator of FIG. 1 taken along line 7-7 in FIG. 1.

FIG. 8 is a cross-sectional view of the ice-gel generator of FIG. 1 taken along line 8-8 in FIG. 1.

FIG. 9 is an isometric view of a dispensing wheel, according to one embodiment.

FIG. 10 is a schematic view of a gel-ice manufacturing system, according to one embodiment.

FIG. 11 is an isometric view of an ice-gel generator, according to another example embodiment.

FIG. 12 is a side elevational view of the ice-gel generator of FIG. 11.

FIG. 13 is a cross-sectional view of the ice-gel generator of FIG. 11 taken along line A-A in FIG. 12.

FIG. 14 is an isometric view of a rotor apparatus of the ice-gel generator shown in FIG. 11.

### DETAILED DESCRIPTION

In the following description, certain specific details are set forth in order to provide a thorough understanding of various disclosed embodiments. However, one of ordinary skill in the relevant art will recognize that embodiments may be practiced without one or more of these specific details. In other instances, well-known structures, systems and techniques associated with ice generators may not be shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

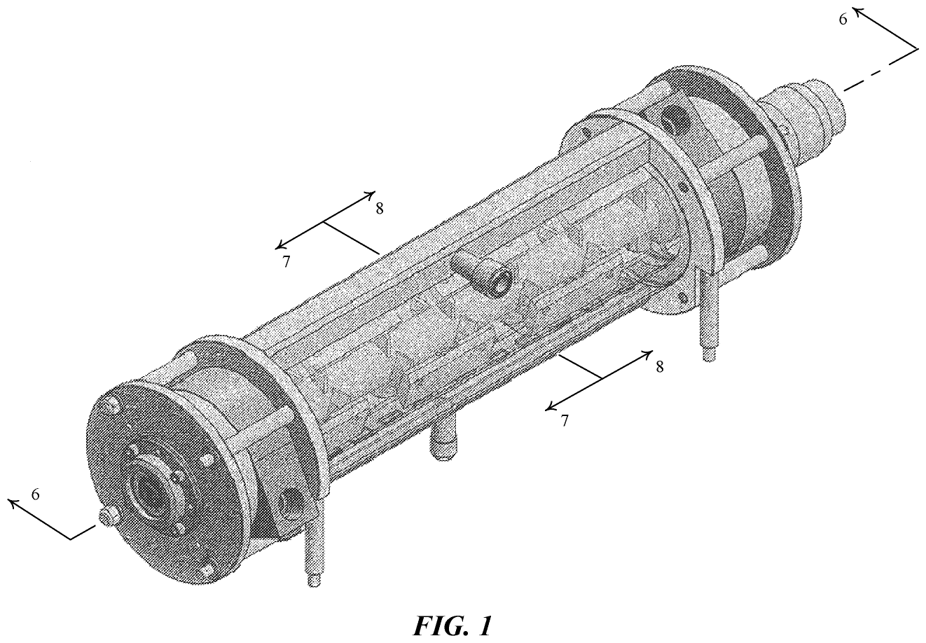

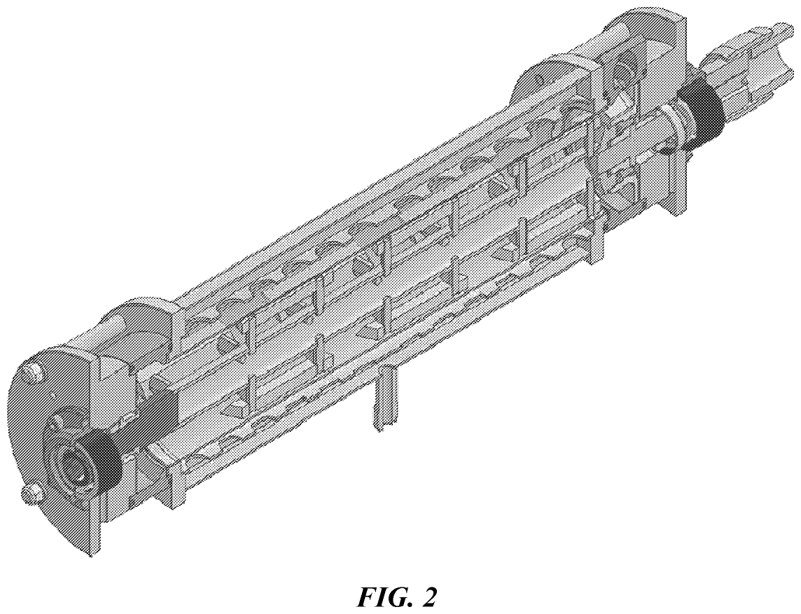

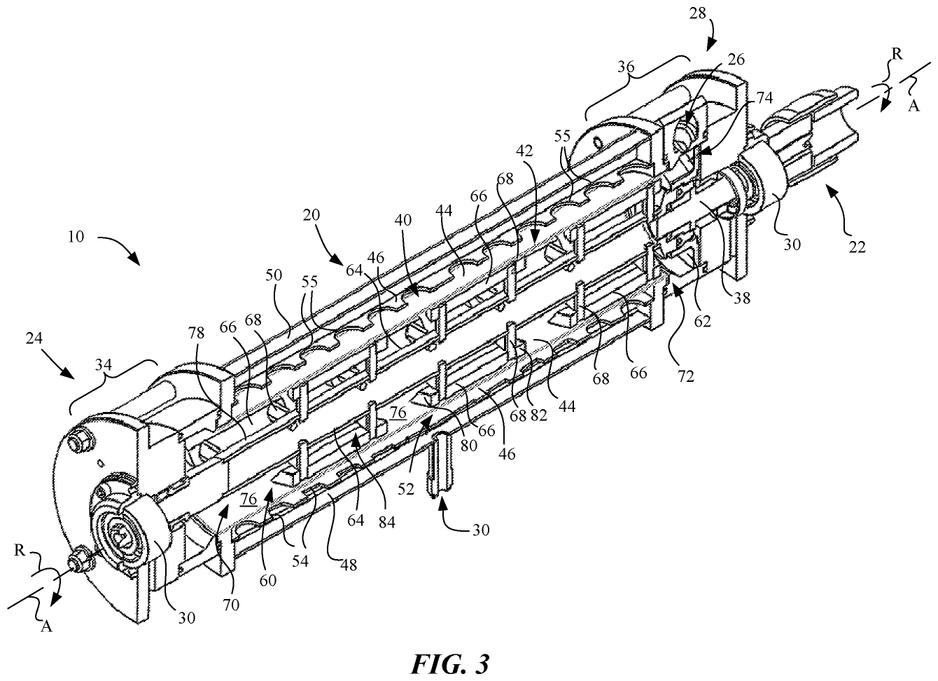

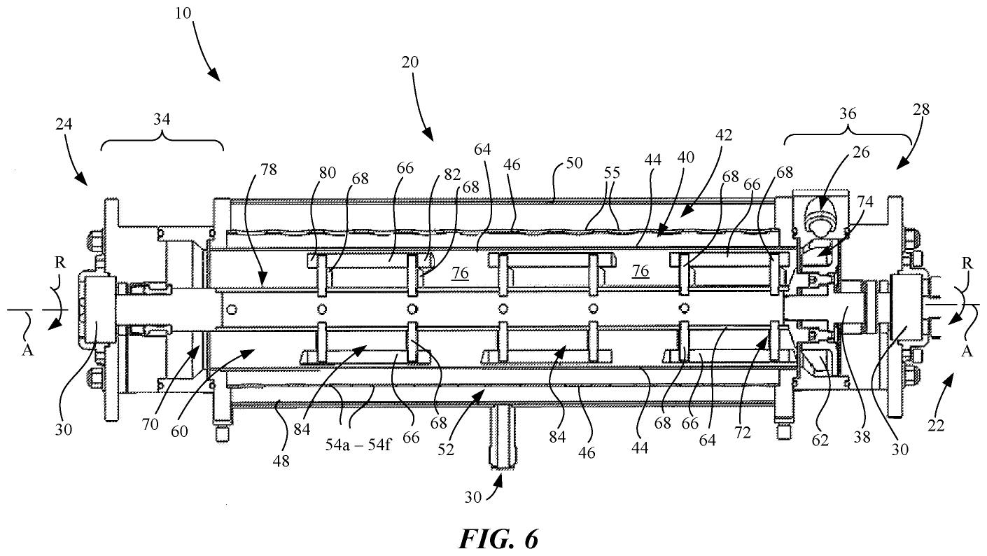

Embodiments described herein provide generators and related systems that are well suited to generate gel-ice to exacting standards in particularly efficient and versatile form factors. FIGS. 1 through 8 show an example embodiment of a gel-ice generator 10 in various views and display conventions to illustrate the various components thereof. FIGS. 1, 2 and 5 provide shaded renderings of the gel-ice generator 10 for additional clarity, while FIGS. 3, 4 and 6-8 provide non-shaded views of the same gel-ice generator 10. For clarity purposes, FIGS. 1, 2 and 5 have not been provided with reference characters, however, it will be appreciated that the reference characters of FIGS. 3, 4 and 6-8 apply equally to the shaded renderings provided therein.

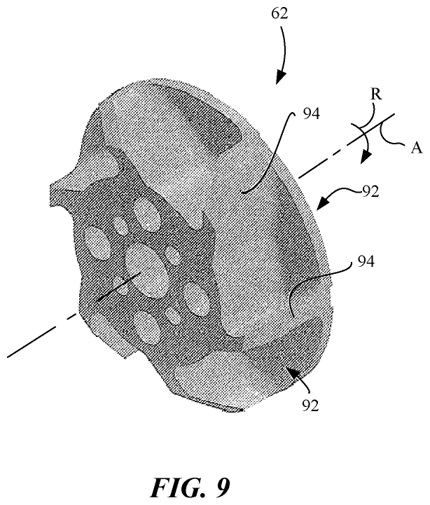

With reference to FIGS. 1 through 7, a gel-ice generator 10 is provided. The gel-ice generator 10 may be part of a more comprehensive processing system that may include, among other things, one or more of the gel-ice generators 10, a fluid source that delivers fluid to the gel-ice generator(s) 10, a coolant source that delivers coolant to the gel-ice generator(s) 10, and a discharge conduit for discharging a supply of gel-ice from the gel-ice generator(s) 10. The fluid source may provide a source of fluid comprising salt water, seawater, sugared water, alcohol, mixtures thereof, or the like, as well as a wide range of different types of freezing level reducing components or additives. The fluid source can include one or more pressurization devices (e.g., a piston pump, a diaphragm pump, a rotary pump, a screw pump, or the like) to deliver fluid to the gel-ice generator(s) 10. The fluid source can also include, without limitation, filter systems, mixers, sensors, valves, controllers, or the like. In certain embodiments, the fluid source is a pump that delivers a liquid from an external liquid source, such as the ocean. The coolant source may provide a source of coolant comprising a refrigerant, such as refrigerant 12 (e.g., FREON®), refrigerant 22 (R-22), refrigerant 134a (R-134a), refrigerant 404a (R-404a), ammonia, or other types of refrigerants. The gel-ice generator(s) 10 may be configured to receive a continuous or intermittent supply of fluid and coolant and to output a continuous or intermittent supply of gel-ice. An example of such a processing system 100 is shown in FIG. 9 and will be described in more detail elsewhere.

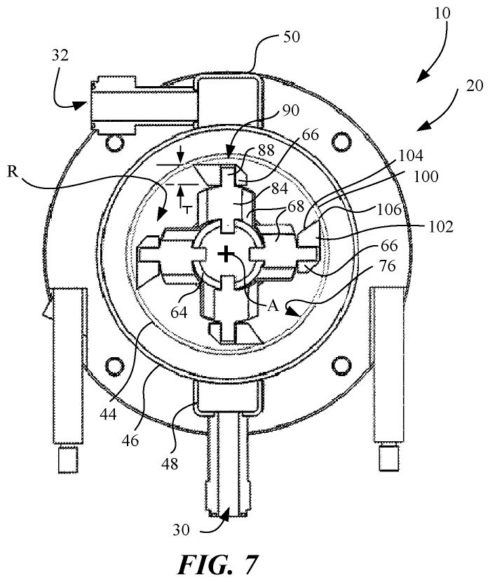

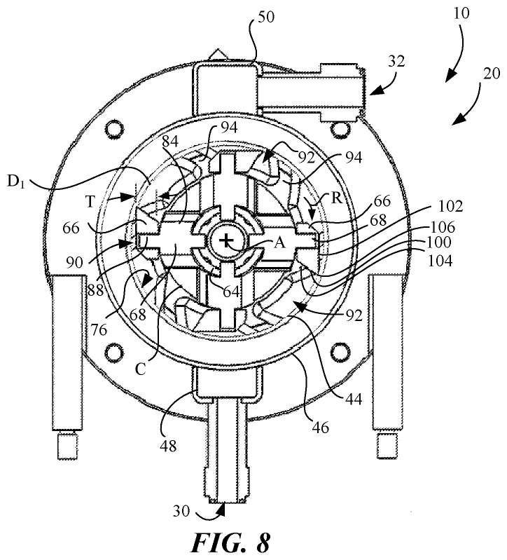

With reference to FIGS. 1 through 8, the gel-ice generator 10 includes a gel-ice formation unit 20 with one or more drive coupling components 22 for connecting the generator 10 to a drive device (not shown). The gel-ice formation unit 20 includes a fluid inlet (unlabeled in FIG. 1) at an inlet end 24 thereof for receiving a fluid and a gel-ice outlet 26 at an outlet end 28 for outputting gel-ice. The fluid inlet may be coupled to a outlet end of a fluid supply conduit (not shown) and the gel-ice outlet 26 may be coupled to an upstream end of a gel-ice discharge conduit (not shown). Although the example embodiment of the gel-ice generator 10 of FIGS. 1 through 8 includes a single fluid inlet and a single gel-ice outlet 26, it is appreciated that in some embodiments, the generators 10 may be provided with a plurality of fluid inlets and/or a plurality of gel-ice outlets 26. When so provided, the inlets and/or outlets may be spaced regularly or irregularly around a circumference of the gel-ice formation unit 20. The gel-ice formation unit 20 also includes a coolant inlet 30 and a coolant outlet 32 (FIGS. 7 and 8). The coolant inlet 30 may be coupled to a outlet end of a coolant supply line (not shown) and the coolant outlet 32 may be coupled to an upstream end of a coolant discharge line (not shown). Although the example embodiment of the gel-ice generator 10 of FIGS. 1 through 8 includes a single coolant inlet 30 and a single coolant outlet 26, it is appreciated that in some embodiments, the generators 10 may be provided with a plurality of coolant inlets and/or a plurality of gel-ice outlets 26. When so provided, the inlets and/or outlets may be spaced regularly or irregularly along a longitudinal length of the gel-ice formation unit 20.

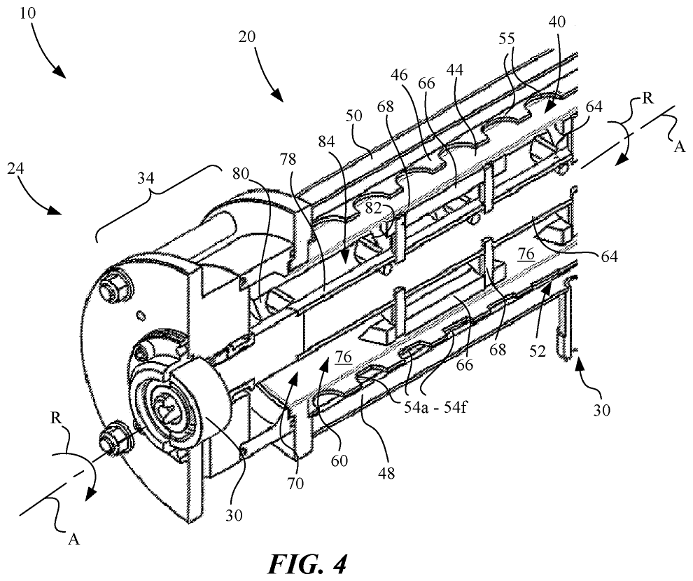

With reference to FIGS. 3 and 4, the drive device, when energized, rotates internal components of the gel-ice formation unit 20 about a longitudinal axis A in the direction shown by the arrows labeled R. For this purpose, internal components of the gel-ice formation unit 20 may be supported on a pair of opposing rotary bearings 30. In some embodiments, the drive device may be provided in the form of an electrical motor, such as a DC motor (for example, a brushed DC motor, a brushless DC motor, or the like) capable of achieving relatively high rotational speeds. Such electric motors can be a single-phase motor or a three-phase motor that operates at a frequency of about 50-60 hertz. In other embodiments, a frequency regulator can be used to operate the motor at about 100 hertz. The motors can operate at about 110 volts to about 480 volts. Other types of motors, such as, for example, a hydraulically driven motor or generator, can also be utilized. In some embodiments, the internal components of the gel-ice formation unit 20 may be coupled directly or indirectly to a single dedicated drive motor, and in other embodiments may be coupled indirectly via one or more drive elements (e.g., gears, belts, etc.) to a drive motor that is configured to drive a plurality of like generators 10.

With continued reference to FIGS. 3 and 4, the gel-ice generator 10 may generally include an inlet assembly 34, a dispenser mechanism 36, and the gel-ice formation unit 20. The dispenser mechanism 36 may be coupled to the one or more drive coupling components 22. A drive shaft 38 of the drive device may also be coupled to the one or more drive coupling components 22, which transmit mechanical energy to the gel-ice formation unit 20.

A cooling jacket 40 for cooling an internal gel-ice producing vessel 42 is provided. The cooling jacket or chamber 40 may be formed, at least in part, of an inner tube 44 that serves as the exterior of the internal gel-ice producing vessel 42, an outer tube or housing 46, a coolant inlet manifold 48, and a coolant outlet manifold 50. In operation, coolant flows through the inlet manifold 48, a coolant chamber 52 at least partially defined between the inner tube 44 and the outer tube or housing 46, and the outlet manifold 52. The coolant in the coolant chamber 52 reduces the temperature of flowable material within the inner tube 44 as it moves from the inlet end 24 of the gel-ice formation unit 20 toward the outlet end 28 of the gel-ice formation unit 20.

With reference to FIG. 4, the outer tube or housing 46 may include a plurality of coolant inlet apertures 54a-54f configured to generate a relatively uniform temperature profile along a longitudinal length of the inner tube 44 opposite the plurality of coolant inlet apertures 54a-54f. The plurality of coolant inlet apertures 54a-54f, may include, for example, at least three distinct apertures 54a-54f, each aperture 54a-54f having a profile area of a different magnitude. The magnitude of the profile area of each aperture 54a-54f may be larger with increasing distance from a location of coolant introduction 56. This may assist in creating a relatively uniform temperature profile along the longitudinal length of the inner tube 44 that is particularly conducive to forming consistently sized ice particles. The plurality of inlet apertures may be symmetrical about two distinct planes of symmetry S₁, S₂.

With reference to FIGS. 3 and 4, The gel-ice formation unit 20 generally includes a rotor apparatus 60 and a dispensing wheel 62 coupled to drive shaft 38 to rotate in unison therewith. The rotor apparatus may include a rotor shaft 64 and a plurality of scraper elements 66 carried by the rotor shaft 64 via a plurality of scraper supports 68. One end 70 of the rotor shaft 64 may be rotatably supported by or otherwise coupled to the bearing 30 at the inlet end 24 of the gel-ice formation unit 20. The opposing end 72 of the rotor shaft 64 may be coupled to the dispensing wheel 62. The dispensing wheel 62 may include an array of compartments 74, as described in more detail elsewhere, each configured to receive and move gel-ice into communication with the gel-ice outlet 26.

With continued reference to FIGS. 3 and 4, the rotor shaft 64 is configured to rotate about the longitudinal axis during operation and to maintain flowable material within an annular column defined between the rotor shaft 64 and an inner surface 76 of the inner tube 44 as the flowable material moves from the inlet end 24 of the gel-ice formation unit 20 toward the outlet end 28 of the gel-ice formation unit 20. Although the rotor shaft 64 is shown as a generally cylindrical, hollow member, it is appreciated that the rotor shaft 64 may take on various forms including solid members and shafts having an external surface that is non-cylindrical, such as, for example a shaft having tapered, stepped, and/or bulbous portions.

The plurality of scraper supports 68 are positioned on the rotor shaft 64 to rotate in unison therewith. As shown in FIGS. 3 and 4, the rotor shaft 64 may comprise a cylindrical member and the scraper supports 68 may extend into the rotor shaft beyond an exterior surface 78 of the rotor shaft 64. The scraper supports 68 may be welded or otherwise joined to the rotor shaft 64, or in other embodiments may be formed integrally with the rotor shaft 64, such as, for example, by casting or other fabrication processes.

The plurality of scraper elements 66 are positioned between the inner surface 76 of the inner tube 44 and the scraper supports 68 to assist in the production of gel-ice as the rotor shaft 64 rotates during operation, as described in further detail elsewhere. To assist in the production of gel-ice, the scraper elements 66 may be movably coupled to the scraper supports 66 to enable radial displacement of the scraper elements 66 during operation. Additionally, in some embodiments, the scraper elements 66 may be movably coupled to the scraper supports 68 in such a manner to enable the scraper elements 66 to tilt or pivot during operation relative to the scraper supports 68. In some instances, the scraper elements 66 may be configured such that during operation the interaction of the flowable material with a portion of the scraper elements 66, such as leading surfaces 104 (Figures land 8) thereof, may drive the scraper elements 66 to tilt relative to the scraper supports 68. In this manner, the scraper elements 66 may more closely engage the inner surface 76 of the inner tube 44. This may assist in dislodging ice crystal formations at the inner surface 76 when the crystals are in particularly miniscule states.

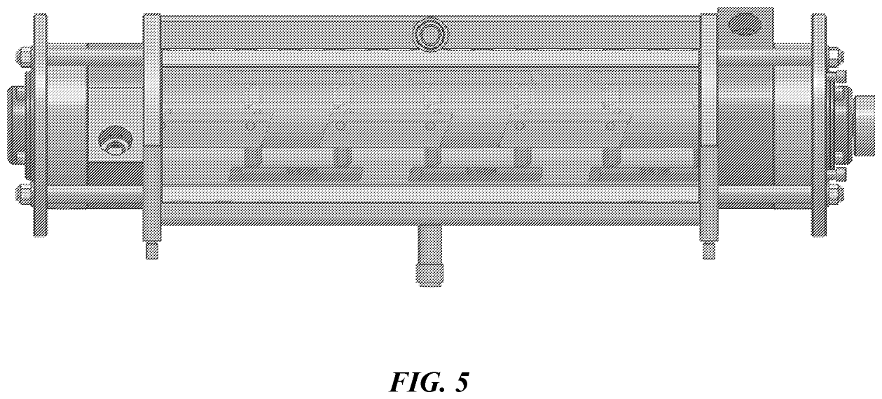

With continued reference to FIGS. 3 and 4, the scraper supports 64 may maintain the scraper elements 66 offset from the exterior surface 78 of the rotor shaft 64 to define a gap or space between the scraper elements 66 and the exterior surface 78. Each scraper element 66 may comprise an elongated element having opposing ends 80, 82, and each scraper element 66 may be supported at each of the opposing ends 80, 82 thereof by a respective scraper support 68. Each scraper element 66 and a pair of respective scraper supports 68 may form a tunnel 84 for the flowable material. The scraper elements 66 may also be arranged in an overlapping manner with respect to a direction along the longitudinal axis A, as shown most clearly in FIG. 5 wherein the outer tube 46 and the inner tube 44 are shown transparent to reveal the scraper elements 66 enclosed therewithin. The size of generated ice particles may be smaller at formation regions corresponding to the areas of such overlap because of the increased frequency with which scraper elements 66 pass a particular point on the inner surface 76 of the inner tube 44.

With reference again to FIGS. 3 and 4, the scraper supports 68 may comprise fin or blade elements. An arrangement of the fin or blade elements may be configured to assist in moving the flowable material from the inlet end 24 of the gel-ice formation unit 20 toward the outlet end 28 of the gel-ice formation unit 20. The arrangement of fin or blade elements may include a plurality of sub-groups spaced along a longitudinal length of the rotor shaft 64, each sub-group including a plurality of the fin or blade elements arranged circumferentially about the rotor shaft 64. This arrangement of the fin or blade elements may be shown best in FIG. 1 wherein the outer tube 46 and the inner tube 44 are shown transparent to reveal the scraper elements 66 and scraper supports 68 enclosed therewithin. As shown, scraper supports 68 in the form of fin or blade elements 68 may be canted relative to a transverse reference plane having a surface normal parallel to the longitudinal axis A. For example, a reference fin or blade plane, which generally bisects a given fin or blade element 68, may be canted relative to the transverse reference plane by at least five degrees, and in some instances between five degrees and forty-five degrees. During operation, the rotor shaft 64 and the fin or blade elements 68 may rotate as a unit to assist in the progression of the flowable material completely external of the rotor shaft 64. In some embodiments, the arrangement of the fin or blade elements 68 may form a conveying screw structure.

With reference to FIGS. 7 and 8, each scraper support 68 may include a base portion 86 and a projection 88 extending radially outward away from the longitudinal axis A and each scraper element 66 may include one or more apertures 90 to receive a corresponding projection 88 of each of one or more of the scraper supports 68 that support the scraper element 66. In some instances, each of the one or more apertures 90 of the scraper element 66 may be sized to loosely receive the corresponding projection 88 of the scraper support 68 to enable the scraper element 66 to tilt relative to the scraper support 68 during operation. For example, the projection 88 may be generally cylindrical and have a diameter that is at least 0.03 inches smaller than a corresponding diameter of the aperture 90 in the scraper element 66. Again, tilting of the scraper element 66 during operation may assist in dislodging ice crystal formations at the inner surface 76 when the crystals are in particularly miniscule states.

With reference to FIGS. 7 and 8, a thickness T of each scraper element 66 is less than half of a radial distance D between the external surface 78 of the rotor shaft 64 and the inner surface 76 of the inner tube 44. In this manner, a collective volume of the scraper elements 66 may be relatively small compared to the column of space formed between the rotor shaft 64 and the inner tube 44.

With reference to FIG. 8, and as discussed earlier, the gel-ice formation unit 20 may include a dispensing wheel 62. The dispensing wheel may be coupled to the rotor shaft 64 and drive shaft 38 at the downstream end 28 of the gel-ice formation unit 20 to rotate in unison with the rotor apparatus 60. The dispensing wheel 62 may include a plurality of compartments 92 configured to receive gel-ice laterally from a direction generally along the longitudinal axis A and to dispense gel-ice radially toward the gel-ice outlet 26. Each compartment 92 may trail away in a direction opposite a direction of rotation of the rotor shaft. Each compartment 90 may include opposing sidewalls 94 that curve away from a direction of rotation of the rotor apparatus 60.

Although the compartments 92 shown in FIG. 8 are shown extending generally from an outer starting position that is radially beyond the outer diameter D₁ of the inner tube 44 inwardly to an inner radial position that is at or near a reference circle C defined by a lower portion of the scraper elements 66, it is appreciated that in other embodiments that each compartment 90 may include a portion that extends from an outer starting position inwardly beyond the reference circle C defined by the lower portion of the scraper elements 66. This may assist in reducing drag or pressure drops of the flowing material through the gel-ice formation unit 20. In addition, although the through the gel-ice formation unit 20 is shown in the example embodiment of FIGS. 1 through 8 as including a dispensing wheel 62 configured to receive gel-ice laterally and to dispense gel-ice radially toward the gel-ice outlet 26, it is appreciated that in other embodiments, the gel-ice outlet 26 may be aligned parallel to the longitudinal axis A and a conveying mechanism, such as a screw or auger device, may be coupled to the drive shaft 38 at the downstream end 28 of the gel-ice formation unit 20 to rotate in unison therewith to move gel-ice toward the gel-ice outlet. This too may assist in reducing drag or pressure drops of the flowing material through the gel-ice formation unit 20.

With reference to FIGS. 7 and 8, the scraper elements 66 may generally include a leading portion 100, an outer surface 102, and a leading surface 104 angled with respect to the outer surface 102. As a leading edge 106 of the leading portion 100 passes through a flowable material, the flowable material can flow along the leading surface 104 or otherwise interact with the leading surface to impart force on the leading surface 104 which may tend to rotate or pivot the scraper element 66 relative to the one or more scraper supports 68 that support the scraper element. The scraper elements 66 can be deployed by centrifugal forces, forces produced due to interaction between the flowable material and the scraper elements 66, or the like.

The scraper elements 66 can be made, in whole or in part, of one or more metals, polymers, ceramics, composites, or other similar materials. Exemplary non-limiting metals include aluminum, steel, titanium, and high strength alloys. For example, the leading edge 106 may be formed of a hardened or high wear material, such as carbide. In other instances, the leading edge 106 may be formed of a polymer, such as, for example, an ultra-high-molecular-weight polyethylene (UHMWPE or UHMW).

Operation of the gel-ice generator 10 will now be generally described with reference to FIG. 4. Generally, a fluid is delivered into the gel-ice formation unit 20. The fluid passes along a column between the rotating rotor shaft 64 and the stationary inner tube 44. As the flowable material proceeds along the gel-ice formation unit 20 towards the dispenser mechanism 36, the amount (by weight or volume) of ice-fractions gradually increases. At least proximate to the downstream end 28, the flowable material can be gel-ice. The gel-ice can flow out of the gel-ice formation unit 20 via the dispensing wheel 62. As the dispensing wheel 62 rotates, its compartments 92 are successively brought into fluid communication with the gel-ice outlet 26. The gel-ice flows through the outlet 26 and along a discharge conduit for subsequent processing, storage or use. The gel-ice manufacturing process is discussed in further detail below.

Referring to FIG. 4, fluid is introduced into the gel-ice formation unit 20 via the fluid inlet (unlabeled, FIG. 1). The fluid proceeds through the gel-ice formation unit 20 towards and past the rotating scraper elements 66 in the annular column formed between the rotor shaft 64 and the inner tube 44. The fluid may also flow between and among the scraper supports 68. In this manner, flowable material fills and circulates within the gel-ice formation unit 20.

The inner tube 44 is chilled and absorbs heat to cool the flowable material. The fluid contacting, or proximate to, the inner surface 76 can become ice-fractions. This is because the fluid reaches a sufficiently low temperature to cause crystallization. The scraper elements 66 can promote the formation of ice-fractions, dislodge ice-fractions from the surface 76, break apart ice-fractions or large ice crystals, promote nucleation of ice-fractions, or otherwise process the flowable material. In certain embodiments, the scraper elements 66 physically contact the surface 76 to form ice-fractions. The ice-fractions move away from the surface 76 and circulate through the gel-ice formation unit 20. In certain embodiments, the scraper elements 66 slide along a portion of the surface 76 to help form and/or dislodge ice-fractions. The scraper elements 66 or other mixing elements can be spaced apart from the surface 76 to assist in mixing the flowable material. The scraper elements 66 or like elements can thus be spaced apart from the inner surface 76, can contact the inner surface 76, or can be proximate to the inner surface 76, thereby providing processing flexibility. Moreover, the scraper supports 68 may be used to further mix and/or move the flowable material through the gel-ice formation unit 20, thereby providing further processing flexibility.

To cool the inner tube 44, coolant (for example, a cold liquid-vapor mixture) passes through the inlet manifold 48. The liquid-vapor mixture flows through apertures 54a-54f and into a coolant chamber 42. The coolant chamber 42 can serve as an evaporation chamber and is between the outer surface 45 of the inner tube 44 and an inner surface of the outer tube 46. The low temperature liquid-vapor mixture flows along the outer surface 45 and absorbs heat, thereby cooling the inner tube 44, including the inner surface 76.

The coolant circulates to keep the inner tube 44 at a relatively low temperature. In some embodiments, the inner surface 44 can be kept at a sufficiently low temperature to cause rapid formation of ice-fractions. For example, the inner surface 44 can be kept at a temperature of about −20° C. to about −10° C. If the starting fluid is salt water, the temperature of the inner surface 44 can be maintained at about −15° C. The temperature of the inner surface 44 can be selected based on the temperature, flow rate, or characteristics (e.g., concentration of salt or sugar in the fluid) of the starting fluid fed into the gel-ice formation unit 20, as well as the desired characteristics of the gel-ice, desired gel-ice generator throughput, or the like.

As the low temperature liquid-vapor mixture absorbs heat, it begins to evaporate. To remove the evaporated coolant (for example, a heated vapor), the coolant is drawn through apertures 55 of the coolant outlet manifold 50. The coolant proceeds through the coolant outlet manifold 50 to the coolant outlet 32 (FIGS. 7 and 8) for discharge.

The rotational speed of the rotor apparatus 60 can be increased or decreased to adjust the properties of the gel-ice. In some processes, the illustrated rotor apparatus 60 may rotate at a rotational speed equal to or greater than about 300 rotations per minute (RPM). Such embodiments are well suited to produce relatively thick gel-ice. In some embodiments, the rotor apparatus 60 is rotated at a rotational speed within a range of about 300 RPM to about 5,000 RPM. To produce ice-fraction components with diameters equal to or less than about 2.5 microns, the rotor apparatus 60 can be rotated about 300 RPM. The rotational speed can be increased to 5,000 RPM to significantly reduce the size of the ice-fraction components. For example, the rotor apparatus 60 can be rotated at a relatively high rotational speed (for example, 3,000 RPM) to form thin gel-ice, even at high feed rates. If the volume flow rate of the flowable material passing through the formation unit 20 is increased or decreased, the rotational speed of the rotor apparatus 60 can also be increased or decreased to maintain the consistency of the gel-ice.

At high rotational speeds, the scraper elements 66 can be kept proximate to or in direct contact with the surface 76 due to, for example, centrifugal forces. For example, the leading edge 106 (FIG. 7) can slide along the inner surface 76 as the rotor apparatus 60 rotates. This may ensure that the scraper elements 66 slide smoothly along the surface 76 to minimize, limit, or substantially eliminate impact forces that may appreciably damage the surface 44 or the scraper elements 66, or both.

Although not illustrated, biasing members, actuators, positioners, or the like can be used to actively position the scraper elements 66 for processing flexibility.

The gel-ice generator 10 of FIGS. 1 through 8 can be incorporated into a wide range of different types of processing systems. If one or more of the gel-ice generators 10 are used on a vessel (e.g., a fishing boat), the gel-ice generators 10 can be configured to process seawater to produce gel-ice used to chill seafood, such as fish, or other creatures harvested from the sea. Such gel-ice generation apparatuses can be portable and transported to different locations in the vessels. In meat processing plants, one or more gel-ice generator 10 can be incorporated into existing available plumbing to deliver gel-ice used to process meat and can be used with available refrigeration systems and fluid supplies.

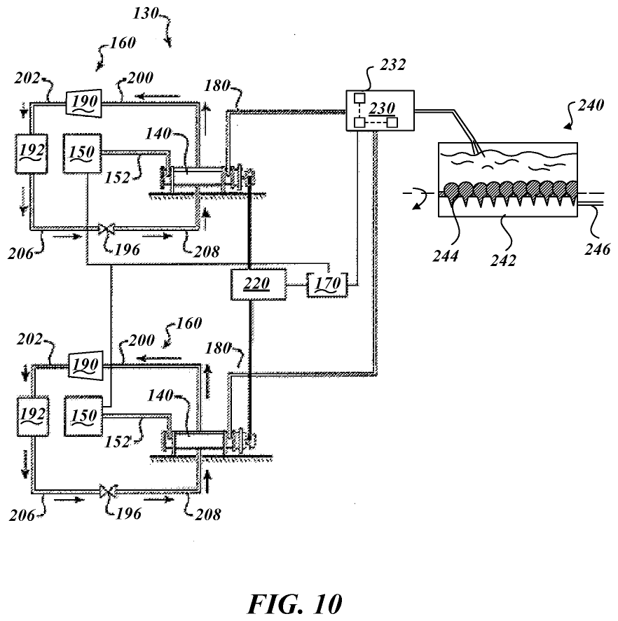

FIG. 10 illustrates an example embodiment of a gel-ice manufacturing system 130. The gel-ice manufacturing system 130 includes one or more gel-ice generators 140, which may be the same or similar to embodiments of the gel-ice generators described herein. The gel-ice manufacturing system 130 further includes, for each generator 140, a fluid supply 150, and a cooling system 160 that delivers a coolant to the gel-ice generator apparatus 140. The fluid supply 150 delivers a fluid to the gel-ice generator apparatus 140, which produces gel-ice from the fluid using the coolant. The gel-ice passes through an output line 180 for subsequent processing, use or storage. Although each generator 140 is shown as including a separate, dedicated fluid supply 150 and cooling system 160, it is appreciated that in some embodiments, a common fluid supply and/or cooling system may be provided to supply fluid and coolant, respectively, to two or more generators 140.

Each cooling system 160, illustrated as a closed loop system, may include a pressurization device 190, a condenser 192, and a valve 196. A fluid line 200 connects the gel-ice generator apparatus 140 to the pressurization device 190. A fluid line 202 connects the pressurization device 190 to the condenser 192. A fluid line 206 connects the condenser 192 to the valve 196. A fluid line 208 connects the valve 196 to the gel-ice generator apparatus 140. Each of the fluid lines 200, 202, 206, 208 can be a conduit, a pipe, a tube or other component through which a coolant can flow. A coolant can be a refrigerant, such as refrigerant 12 (e.g., FREON®), refrigerant 22 (R-22), refrigerant 134a (R-134a), refrigerant 404a (R-404a), ammonia, or other types of refrigerants. Advantageously, each cooling system 160 can recondition the coolant such that the coolant can be repeatedly delivered to the gel-ice generator apparatus 140. If ammonia is utilized, the cooling system 160 may or may not have a compressor. For example, a series of valves can be used to recondition the ammonia.

A line 152 connects each fluid supply 150 to the respective gel-ice generator 140. The fluid supply 150 can contain salt water, seawater, sugared water, alcohol, mixtures thereof, or the like, as well as a wide range of different types of freezing level reducing components or additives.

The fluid supply 150 can include one or more pressurization devices (e.g., a piston pump, a diaphragm pump, a rotary pump, a screw pump, or the like) to pump the fluid through the line 152. In some embodiments, the fluid supply 150 includes multiple containers, each containing a different fluid. For example, one container can hold salt water or sugared water. Another container can hold another liquid, such as alcohol. The different liquids can be delivered through separate lines to the respective gel-ice generator 140. The fluids can be mixed within the gel-ice generator apparatus 140. In other embodiments, liquids are mixed within the fluid supply 150. The mixture is then delivered to the gel-ice generator apparatus 140. The fluid supply 150 can also include, without limitation, filter systems, mixers, sensors, valves, controllers, or the like.

A controller 170 is communicatively coupled to each gel-ice generator 140, as well as other components or systems, such as the cooling system 160 or the fluid supply 150, or both. Different types of wired or wireless connections can be used to provide communication between the controller 170 and the other devices. The controller 170 can adjust processing variables, including, without limitation, operating speeds (e.g., a rotational speed of a mixing apparatus), processing temperatures, working pressures, flow rates (e.g., gel-ice flow rates, starting fluid flow rates, flowable material flow rates, or the like). The term “flowable material” can refer to one or more fluids, a gel-ice, mixtures thereof, or the like. For example, a flowable material can be a liquid, such as saltwater, sugared water, alcohol, or the like. The controller 170 can be communicatively coupled to and command a drive device 220 to rotate the rotor apparatus of the gel-ice generator apparatus 140 to process such flowable materials to produce gel-ice having ice-fractions with a diameter equal to or less than, for example, about 2.5 microns. In some embodiments, the controller may be communicatively coupled to the drive device 220 and configured to command the drive motor 220 to rotate each respective rotor apparatus of two or more generators 140 concurrently to generate gel-ice via each such generator 140.

The controller 170 generally includes, without limitation, one or more central processing units, processing devices, microprocessors, digital signal processors (DSP), application-specific integrated circuits (ASIC), readers, and the like. To store information, controllers also include one or more storage elements, such as volatile memory, non-volatile memory, read-only memory (ROM), random access memory (RAM), and the like. Controllers can include displays to display information, such as gel-ice characteristics, processing temperatures, flow rates (e.g., volume flow rates), flow velocities, or the like. Example displays include, but are not limited to, LCD screens, monitors, analog displays, digital displays (e.g., light emitting diode displays), or other devices suitable for displaying information. The term “information” includes, without limitation, one or more programs, executable code or instructions, routines, relationships (e.g., gel-ice flowability versus processing temperatures, flow sensor signals versus volume flow rates, etc.), data, operating instructions, combinations thereof, and the like. For example, information may include one or more temperature settings, flow rate settings, pressure settings, drive device speeds, or the like.

The controller 170 can also monitor processing based on feedback from various devices. For example, the controller 170, in some embodiments, may determine the characteristics of the material in the gel-ice generator 140 based on the torque applied by the drive device 220. If a relatively thick gel-ice is formed in the gel-ice generator(s) 140, the drive device 220 may apply a relatively high torque to maintain a high rotational speed of the rotor apparatus thereof. If the gel-ice in the gel-ice generator(s) 140 is a thin gel-ice, the torque applied by the drive device 220 can be relatively low.

As another example, an inspection system 230 including one or more sensors 232 may be provided in fluid communication with the one or more gel-ice generators 140. The inspection system 230 may at least periodically inspect one or more characteristics of gel-ice generated by the gel-ice generator(s) 140 and generate an inspection signal in response thereto. The controller 170 may be communicatively coupled to the gel-ice generator(s) and the inspection system, and may be configured to adjust one or more operational parameters of the gel-ice generator (i.e., rotational speed, rate of fluid input, etc.) based at least in part on the inspection signal generated by the inspection system 230.

In some embodiments, the fluid supply 150 may further include a freezing level reducing agent control apparatus configured to receive a source of fluid and adjust a concentration of a freezing level reducing agent therein. Moreover, the controller may be communicatively coupled to the gel-ice generator(s) 140 and the freezing level reducing agent control apparatus and configured to independently control one or more operational parameters of the freezing level reducing agent control apparatus and the gel-ice generator to selectively adjust characteristics of the generated gel-ice. In some embodiments, the controller may also be configured to adjust a concentration of a freezing level reducing agent based at least in part on the inspection signal generated by the inspection system 230 discussed described above. More particularly, in some instances, the freezing level reducing agent control apparatus may be configured to receive a source of water and adjust a salinity thereof, such as, for example, between about 0.9% to about 5.0% (% w/v), based at least in part on the inspection signal generated by the inspection system 230. The salinity may be adjusted based on a number of different factors, including the desired end use of the gel-ice.

With continued reference to FIG. 10, the gel-ice manufacturing system 130 may further include a storage system 240 comprising a refrigerated tank 242 to receive the generated gel-ice and temporarily store a supply of the same for selective discharge through a tank outlet 246. The refrigerated tank 242 may include a rotatable auger 244 to at least periodically mix gel-ice deposited in the refrigerated tank 242. The gel-ice generators 140 can continuously or intermittently deliver gel-ice to the storage system 240. Additionally, the gel-ice generators 140 can deliver gel-ice to the storage system 240 simultaneously or separately. The storage system 240 may also be communicatively coupled to the controller and alert the controller 170 when a level of gel-ice in refrigerated tank 242 is below a threshold level and/or above a different threshold level. The controller 170 may control one or more of the generators 140 to produce more gel-ice when the tank 242 is low and to stop or halt production when the tank is full. These and other functionalities may be provided via the controller 170 and the connected devices (e.g., inspection system 230, storage system 240, etc.).

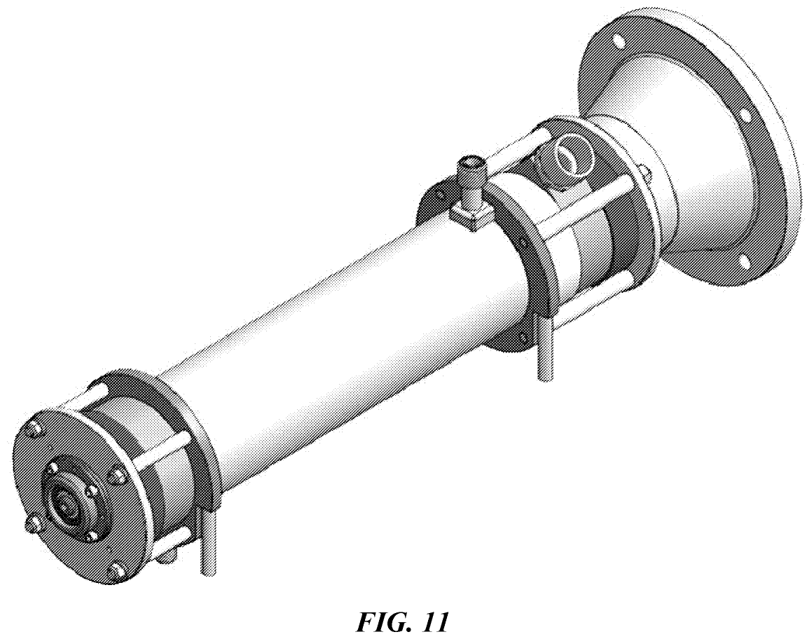

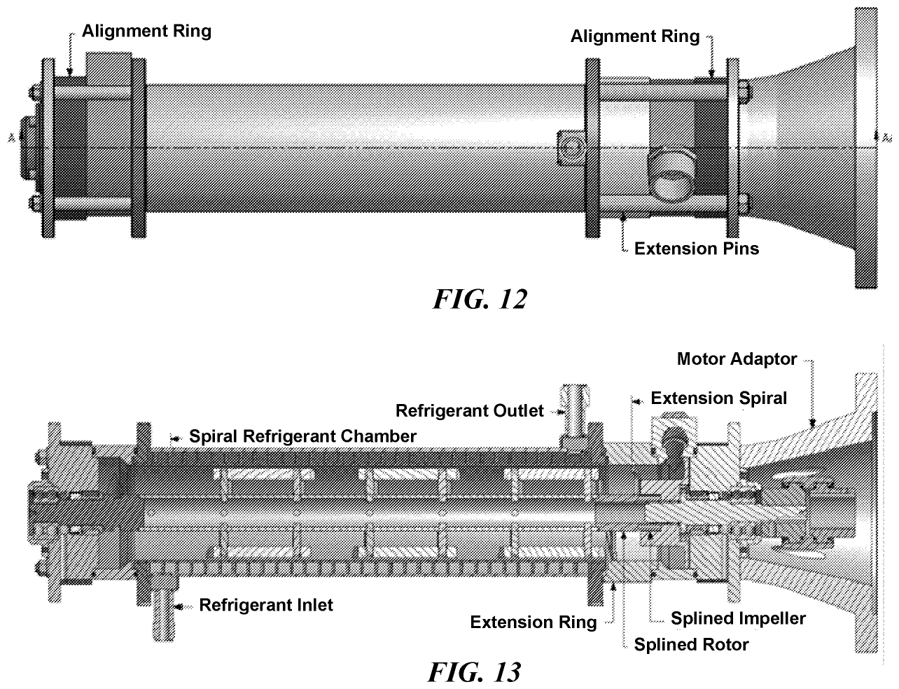

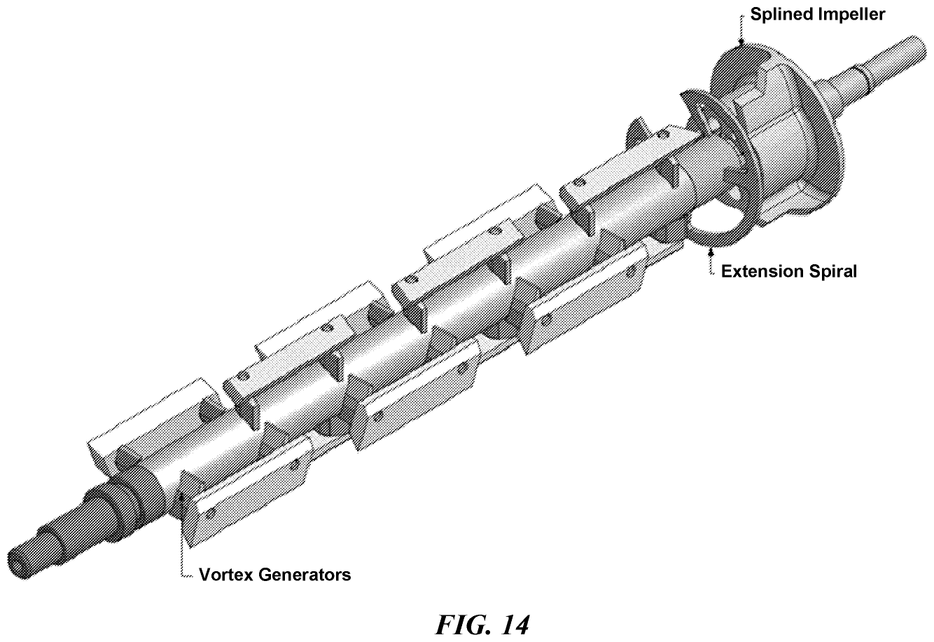

FIGS. 11 through 14 show another example embodiment of a gel-ice generator in various views, which has features and structures similar to those of the gel-ice generator 10 shown in FIGS. 1 through 8. For purposes of brevity, some of the features and structures similar to those of the gel-ice generator 10 of FIGS. 1 through 8 are not repeated here.

Notably, the gel-ice generator of FIGS. 11 through 14 includes one or more partitions arranged within the coolant chamber to provide a coolant passageway that spirals around an inner tube of the generator that defines at least a portion of a gel-ice formation chamber. According to the illustrated embodiment, the coolant passage spirals along the entirety or nearly the entirety of a longitudinal length of the inner tube between a coolant inlet location and a coolant outlet location to distribute coolant relatively evenly around and along the circumferential outer surface of the inner tube to promote the efficient formation of gel-ice within the gel-ice formation chamber.

The gel-ice generator of FIGS. 11 through 14 also includes an extension spiral coupled to a rotor shaft at an outlet end of a gel-ice formation chamber downstream of scraper elements to assist in moving the gel-ice toward a gel-ice outlet. As shown, the extension spiral includes an outer member making at least one full revolution about the rotor shaft and which is configured to move gel-ice forward toward the gel-ice outlet. The outer member may be supported away from a surface of the rotor shaft by a plurality of standoffs. The extension spiral may be positioned at the outlet end of the gel-ice formation chamber between an arrangement of the scraper elements and a dispensing wheel that is likewise coupled to the rotor shaft to rotate in unison therewith and which has a plurality of compartments configured to receive gel-ice laterally and to dispense gel-ice radially. The extension spiral may feed gel-ice from the upstream scraper elements to the downstream dispensing wheel in a particularly efficient manner.

Moreover, features and aspects of the various embodiments described above can be combined to provide further embodiments. All of the U.S. patents, U.S. patent application publications, U.S. patent applications, U.S. Provisional Patent Application No. 62/576,003, filed Oct. 23, 2017, to which the present application claims priority, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A gel-ice generator apparatus, comprising:
an inner tube having an inner surface defining at least a portion of a gel-ice formation chamber that includes an inlet end and an outlet end;
an outer tube surrounding the inner tube to define a coolant chamber between the outer tube and the inner tube;
one or more partitions arranged within the coolant chamber to provide a coolant passageway that spirals around the inner tube along at least a portion of a longitudinal length of the inner tube between a coolant inlet location and a coolant outlet location, and
a rotor apparatus to assist in moving flowable material through the gel-ice formation chamber, the rotor apparatus including a rotor shaft and a plurality of scraper elements positioned in the gel-ice formation chamber, the rotor shaft and the scraper elements configured to rotate about a longitudinal axis during operation and to maintain flowable material within an annular column defined between the rotor shaft and the inner surface of the inner tube as the flowable material moves from the inlet end of the gel-ice formation chamber toward the outlet end of the gel-ice formation chamber gel-ice generator.

2. The gel-ice generator apparatus of claim 1, further comprising:
a plurality of scraper supports positioned on the rotor shaft to rotate in unison therewith, and wherein the plurality of scraper elements are positioned between the inner surface of the inner tube and the scraper supports to assist in the production of gel-ice as the rotor shaft rotates during operation.

3. The gel-ice generator apparatus of claim 2 wherein the scraper supports maintain the scraper elements offset from the rotor shaft to define a gap between the scraper elements and an exterior surface of the rotor shaft.

4. The gel-ice generator apparatus of claim 2 wherein the scraper elements are movably coupled to the scraper supports to enable radial displacement of the scraper elements during operation.

5. The gel-ice generator apparatus of claim 2 wherein the scraper elements are movably coupled to the scraper supports to enable the scraper elements to tilt during operation.

6. The gel-ice generator apparatus of claim 5 wherein the scraper elements include a leading surface configured such that interaction of the flowable material with the leading surface during operation drives the scraper elements to tilt relative to the scraper supports.

7. The gel-ice generator apparatus of claim 5 wherein the scraper elements are arranged in an overlapping manner with respect to a direction along the longitudinal axis, the size of generated ice particles being smaller at formation regions corresponding to the areas of overlap.

8. The gel-ice generator apparatus of claim 2 wherein each scraper element comprises an elongated element having opposing ends, and wherein each scraper element is supported at each of the opposing ends thereof by a respective scraper support.

9. The gel-ice generator apparatus of claim 2 wherein each scraper element and a pair of respective scraper supports form a tunnel for the flowable material.

10. The gel-ice generator apparatus of claim 2 wherein the scraper supports comprise blade elements.

11. The gel-ice generator apparatus of claim 10 wherein an arrangement of the blade elements is configured to assist in moving the flowable material from the inlet end of the gel-ice formation chamber toward the outlet end of the gel-ice formation chamber.

12. The gel-ice generator apparatus of claim 10 wherein an arrangement of the blade elements includes a plurality of blade sub-groups spaced along a longitudinal length of the rotor shaft, each blade sub-group including a plurality of the blade elements arranged circumferentially about the rotor shaft.

13. The gel-ice generator apparatus of claim 10 wherein the rotor shaft and the blade elements rotate as a unit to assist in the progression of the flowable material completely external of the rotor shaft.

14. The gel-ice generator apparatus of claim 10 wherein the blade elements are canted relative to a transverse reference plane.

15. The gel-ice generator apparatus of claim 10 wherein an arrangement of the blade elements forms an intermittent conveying screw structure.

16. The gel-ice generator apparatus of claim 2 wherein each scraper support includes a projection extending radially outward away from the longitudinal axis, and wherein each scraper element includes an aperture to receive the projection.

17. The gel-ice generator apparatus of claim 16 wherein the aperture of the scraper element is sized to loosely receive the projection of the scraper support to enable the scraper element to tilt relative to the scraper support during operation.

18. The gel-ice generator apparatus of claim 1 wherein an external diameter of the rotor shaft is less than half of an internal diameter of the inner tube.

19. The gel-ice generator apparatus of claim 1 wherein an external surface of the rotor shaft is non-cylindrical.

20. The gel-ice generator apparatus of claim 1 wherein a thickness of each scraper element is less than half of a radial distance between the external surface of the rotor shaft and the inner surface of the inner tube.

21. The gel-ice generator apparatus of claim 1, further comprising:
a plurality of fluid inlet ports in fluid communication with the inlet end of the gel-ice formation chamber; and
a plurality of fluid outlet ports in fluid communication with the outlet end of the gel-ice formation chamber.

22. The gel-ice generator apparatus of claim 1, further comprising:
a dispensing wheel coupled to the rotor shaft at the outlet end of the gel-ice formation chamber to rotate in unison with the rotor shaft, the dispensing wheel having a plurality of compartments configured to receive gel-ice laterally and to dispense gel-ice radially.

23. The gel-ice generator apparatus of claim 1, further comprising:
a dispensing wheel coupled to the rotor shaft at the outlet end of the gel-ice formation chamber to rotate in unison with the rotor shaft, the dispensing wheel having a plurality of compartments configured to receive gel-ice laterally and to dispense gel-ice radially, each compartment including opposing sidewalls that curve away from a direction of rotation of the rotor shaft.

24. The gel-ice generator apparatus of claim 1, further comprising:
a dispensing wheel coupled to the rotor shaft at the outlet end of the gel-ice formation chamber to rotate in unison with the rotor shaft, the dispensing wheel having a plurality of compartments configured to receive gel-ice laterally and to dispense gel-ice radially, each compartment including a portion that extends radially inward beyond a reference circle defined by the scraper elements.

25. The gel-ice generator apparatus of claim 1, further comprising:
a dispensing wheel coupled to the rotor shaft at the outlet end of the gel-ice formation chamber to rotate in unison with the rotor shaft, the dispensing wheel having a plurality of compartments configured to receive gel-ice laterally and to dispense gel-ice radially, each compartment including a portion that extends radially inward proximate a reference circle defined by an exterior surface of the rotor shaft.

26. The gel-ice generator apparatus of claim 1, further comprising:
a gel-ice outlet aligned parallel to the longitudinal axis; and
a conveying mechanism coupled to the rotor shaft at the outlet end of the gel-ice formation chamber to rotate in unison therewith, the conveying mechanism configured to move gel-ice toward the gel-ice outlet.

27. The gel-ice generator apparatus of claim 1, wherein the scraper elements are freely movable away from and towards the inner surface of the inner tube to promote forming of ice-fractions with diameters less than about 2.5 microns.

28. The gel-ice generator apparatus of claim 1, wherein the scraper elements are arranged such that a concentric spacing between leading edges of concentrically adjacent scraper elements varies along the longitudinal axis in a stepped manner.

29. The gel-ice generator apparatus of claim 28, wherein the gel-ice generated during operation includes a bi-modal size distribution based at least upon the variance in concentric spacing between the leading edges of the concentrically adjacent scraper elements along the longitudinal axis.

30. The gel-ice generator apparatus of claim 1, further comprising:
an extension spiral coupled to the rotor shaft at the outlet end of the gel-ice formation chamber downstream of the scraper elements, the extension spiral including an outer member making at least one full revolution about the rotor shaft and being configured to move gel-ice toward the gel-ice outlet.

31. The gel-ice generator apparatus of claim 30, further comprising:
a dispensing wheel coupled to the rotor shaft at the outlet end of the gel-ice formation chamber downstream of the extension spiral to rotate in unison with the rotor shaft, the dispensing wheel having a plurality of compartments configured to receive gel-ice laterally and to dispense gel-ice radially.

32. A gel-ice manufacturing system, comprising:
a drive motor;
a plurality of gel-ice generators configured to receive fluid from a fluid supply, each gel-ice generator including
a container having a gel-ice formation chamber through which fluid from the fluid supply flows during operation,
a cooling mechanism surrounding the container and through which a coolant is capable of flowing to cool contents in the gel-ice formation chamber, and
a rotor apparatus coupled to the drive motor, the rotor apparatus including a rotor shaft in the gel-ice formation chamber and a plurality of scraper elements carried by the rotor shaft to rotate in unison therewith; and
a controller communicatively coupled to the drive motor, the controller being configured to command the drive motor to rotate each respective rotor apparatus concurrently to generate gel-ice via each of the plurality of gel-ice generators.

33. A gel-ice manufacturing system, comprising:
a gel-ice generator configured to receive fluid from a fluid supply and discharge gel-ice, the gel-ice generator including
a container having a gel-ice formation chamber through which fluid from the fluid supply flows during operation,
a cooling mechanism surrounding the container and through which a coolant is capable of flowing to cool contents in the gel-ice formation chamber, and
a rotor apparatus including a rotor shaft in the gel-ice formation chamber and a plurality of scraper elements carried by the rotor shaft to rotate in unison therewith;
an inspection system including one or more sensors, the inspection system being in fluid communication with the gel-ice generator to at least periodically inspect one or more characteristics of gel-ice generated by the gel-ice generator and to generate an inspection signal in response thereto; and
a controller communicatively coupled to the gel-ice generator and the inspection system, the controller being configured to adjust one or more operational parameters of the gel-ice generator based at least in part on the inspection signal generated by the inspection system.

34. The gel-ice manufacturing system of claim 33, further comprising:
a freezing level reducing agent control apparatus configured to receive a source of fluid and adjust a concentration of a freezing level reducing agent therein based at least in part on the inspection signal generated by the inspection system.

35. The gel-ice manufacturing system of claim 34 wherein the freezing level reducing agent control apparatus is configured to receive a source of water and adjust a salinity thereof based at least in part on the inspection signal generated by the inspection system.

36. A gel-ice manufacturing system, comprising:
a gel-ice generator configured to receive fluid from a fluid supply and discharge gel-ice, the gel-ice generator including
a container having a gel-ice formation chamber through which fluid from the fluid supply flows during operation,
a cooling mechanism surrounding the container and through which a coolant is capable of flowing to cool contents in the gel-ice formation chamber, and
a rotor apparatus including a rotor shaft in the gel-ice formation chamber and a plurality of scraper elements carried by the rotor shaft to rotate in unison therewith;
a freezing level reducing agent control apparatus configured to receive a source of fluid and adjust a concentration of a freezing level reducing agent therein; and
a controller communicatively coupled to the gel-ice generator and the freezing level reducing agent control apparatus, the controller being configured to independently control one or more operational parameters of the freezing level reducing agent control apparatus and the gel-ice generator to selectively adjust characteristics of the generated gel-ice.

37. The gel-ice manufacturing system of claim 36 wherein the freezing level reducing agent control apparatus is configured to receive a source of water and adjust a salinity thereof.

38. The gel-ice manufacturing system of claim 37 wherein the freezing level reducing agent control apparatus is configured to receive the source of water and adjust the salinity thereof to between about 0.9% to about 5.0% (% w/v).

39. The gel-ice manufacturing system of claim 36, further comprising:
an inspection system including one or more sensors, the inspection system being in fluid communication with the gel-ice generator to at least periodically inspect one or more characteristics of gel-ice generated by the gel-ice generator and to generate an inspection signal in response thereto.

40. The gel-ice manufacturing system of claim 39 wherein the controller is communicatively coupled to the inspection system, the controller being configured to adjust one or more operational parameters of the gel-ice generator based at least in part on the inspection signal generated by the inspection system.

41. A gel-ice manufacturing system, comprising:
a gel-ice generator configured to receive fluid from a fluid supply and discharge gel-ice, the gel-ice generator including
a container having a gel-ice formation chamber through which fluid from the fluid supply flows during operation,
a cooling mechanism surrounding the container and through which a coolant is capable of flowing to cool contents in the gel-ice formation chamber, and
a rotor apparatus including a rotor shaft in the gel-ice formation chamber and a plurality of scraper elements carried by the rotor shaft to rotate in unison therewith; and
a refrigerated storage tank in fluid communication with the gel-ice generator, the refrigerated storage tank including a rotatable auger to at least periodically mix gel-ice deposited in the refrigerated storage tank from the gel-ice generator during operation.
